(19) United States
(12) Patent Application Publication
(10) Pub. No.: US 2006/0230850 A1
(43) Pub. Date: Oct. 19, 2006

(54) Thread drive with monitored safety nut

(76) Inventors: Michael Klein, Grafenrheinfeld (DE); Rudolf Schlereth, Burkardroth-Frauenroth (DE); Roland Greubel, Ramsthal (DE); Werner Blaurock, Niederwerrn (DE)

Correspondence Address: STRIKER, STRIKER & STENBY, 103 EAST NECK ROAD, HUNTINGTON, NY, 11743, US

(21) Appl. No.: 11/404,606

(22) Filed: Apr. 14, 2006

(30) Foreign Application Priority Data
Apr. 15, 2005 (DE) 10 2005 017 429.9

(51) Int. Cl. F16H 27/02

(52) U.S. Cl. 74/89.23

(57) ABSTRACT

A thread drive has a threaded spindle, a load-bearing nut that is in screwing engagement with the threaded spindle, a safety nut connected to the load-bearing nut in a manner fixed against relative rotation, which is likewise in screwing engagement with the threaded spindle, the safety nut having at least one contact portion which has no contact with the threaded spindle in a first operating state of the thread drive and has contact with the threaded spindle in a second operating mode of the thread drive, so that in the first operating state there is no electrically conductive connection between the at least one contact portion of the safety nut and the threaded spindle.

### CROSS-REFERENCE TO A RELATED APPLICATION

The invention described and claimed hereinbelow is also described in German patent application DE 10 2005 017 429.9 filed on Apr. 15, 2005. This German patent application, whose subject matter is incorporated here by reference, provides the basis for a claim of priority of invention under 35 U.SC. 119(a)-(d).

### BACKGROUND OF THE INVENTION

The present invention relates to a thread drive. More particularly, it relates to a thread drive with a monitoring safety nut.

One such thread drive is known from German Patent DE 196 25 999 C2, for instance. There, in FIG. 1, a thread drive 10 with a threaded spindle 12, a load-bearing nut 14 and a safety nut 18 is shown. The load-bearing nut and safety nut are connected to one another in a manner fixed against relative rotation and are each in screwing engagement with the threaded spindle. In a first operating state, namely the normal operating mode of the thread drive, only the load-bearing nut transmits the axial forces that occur from the higher-order component unit 16 to the threaded spindle. The safety nut does not touch the threaded spindle. In a second operating state, namely whenever the load-bearing nut is worn or broken and can no longer transmit any axial forces, the safety nut comes into contact with the threaded spindle and transmits the axial forces, so that the higher-order component unit cannot fall out.

To make it possible to detect the breakage of the load-bearing nut reliably, a safety switch 22 is provided, which outputs a signal in the second operating state. The safety switch is fixed relative to the load-bearing nut, and with an indexing roller 24 it touches the safety nut, or an indexing cam 27 provided there. At the transition from the first operating state to the second operating state, the safety nut shifts relative to the load-bearing nut, so that the indexing cam actuates the safety switch. This construction has the disadvantage of being very complicated.

### SUMMARY OF THE INVENTION

It is therefore the object of the invention to provide a thread drive, in particular with a monitoring safety nut.

This object is attained by providing that in the first operating state, there is no electrically conductive connection between at least one contact portion of the safety nut and the threaded spindle. In particular, the normally present current path from the safety nut via the load-bearing nut to the threaded spindle is meant to be interrupted. This creates an electrical switch between the threaded spindle and the contact portion of the safety nut. In the first operating state, no current can flow, because the contact portion of the safety nut has no contact or any electrical connection, either, with the threaded spindle. In the second operating state, however, current can flow, because there is contact between the contact portion of the safety nut and the threaded spindle.

The contact portion of the safety nut can surround the entire safety nut or only a small portion of it. The first embodiment is simpler in construction, since the second embodiment is predominantly considered for use when already existing safety nut constructions are being upgraded. The contact portion of the safety nut may for instance be embodied as a thin disk, whose internal contour is embodied as equidistant from the surface of the threaded spindle.

For interrupting the electrical connection between the contact portion of the safety nut and the threaded spindle, the contact portion of the safety nut may be provided with an electrically insulating coating. The coating is preferably interrupted only in the contact region with the threaded spindle. The contact portion of the safety nut can therefore be secured without problems to such electrically conductive connection means as screws on the remaining safety nut, or on the load-bearing nut, without interrupting the electrical insulation.

The electrical connection may, however, also be interrupted by a separate electrically nonconductive component, such as a plastic disk. In that case, care must be taken that the connection among the various components also be embodied as electrically nonconductive, for instance as an adhesive bond.

It may also be provided that the load-bearing nut is embodied as a roller body circulation nut, and the electrical connection between the contact portion of the safety nut and the threaded spindle is interrupted by roller bodies of electrically nonconductive material, preferably ceramic balls. In a thread drive of the invention, the use of a roller body circulation nut is in principle advantageous, because it functions virtually without wear. It is thus assured that the gap between the safety nut and the threaded spindle is preserved over the entire service life. Using electrically nonconductive roller bodies means that the electrical connection between the nut body and the threaded spindle can easily be interrupted, since these two components do not otherwise touch. In addition, an electrically nonconductive lubricant for the roller bodies may be provided.

Preferably, the contact portion of the safety nut is embodied as at least partly elastically shiftable relative to the load-bearing nut. As a result, a defined contact pressure is attained at the electrical contact point, so that a secure electrical transition occurs. The contact pressure is due to the structurally defined deformation and to the elasticity of the components involved. The deformation may for instance be set such that the contact portion of the safety nut has a lesser spacing from the threaded spindle than the load-bearing portion of the safety nut. The elasticity may for instance be generated by providing that the aforementioned plastic disk comprises an elastic material, such as rubber.

In the thread drive of the invention, an evaluation device may be provided, which is electrically connected to the contact portion of the safety nut and to the threaded spindle. An electrical voltage can be applied to these components, and the evaluation device monitors whether an electrical current is flowing, or not. If it is flowing, a signal is output that indicates that the thread drive has failed. Ground potential may applied to the threaded spindle, so that avoiding an unwanted flow of current does not require that the threaded spindle be complicatedly insulated electrically from the higher-order component unit.

Furthermore, the threaded spindle can be rotatably supported on at least one bearing, and the electrical connection between the evaluation device and the threaded spindle extends via the bearing. Typically in a thread drive, the threaded spindle is driven rotatably by a motor. For reducing an electrical connection between the threaded spindle and the evaluation device, a transmitter of rotation would thus have to be used. That function can easily be taken over by the bearing of the threaded spindle, especially whenever a radial roller bearing is used, since such a roller bearing is typically electrically conductive. Since in normal operation, namely in the first operating state, electrical current does not flow through the bearing, nor is a voltage applied between the inner and outer rings, there is no need to fear bearing damage.

In a refinement of the invention, it is proposed that the contact region between the contact portion of the safety nut and the threaded spindle is sealed off from the environment. For the functional safety of the monitoring, it is decisive that an electrical contact between the portion of the safety nut and the threaded spindle is not unintentionally made as a result of dirt particles, such as metal chips. This can be prevented by means of a seal. If a roller body circulation nut is used as the load-bearing nut, sealing it is necessary anyway. It is therefore advantageous if one seal is located on each of the two end regions of the load-bearing nut and safety nut combination.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a rough schematic sectional view of a thread drive according to the invention; and

FIG. 2 is a partial sectional view of the safety nut of the thread drive in FIG. 1.

### DESCRIPTION OF THE PREFERRED EMBODIMENT

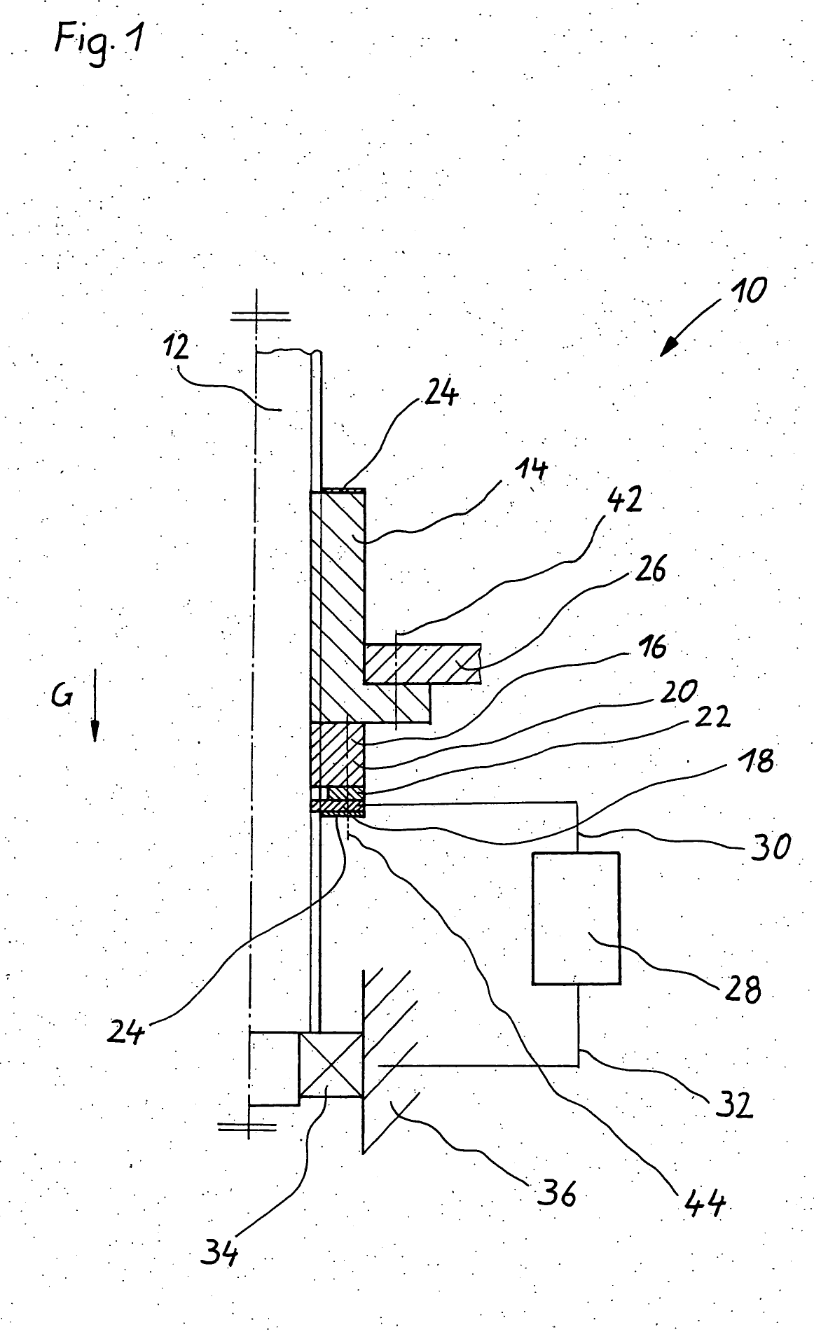

In FIG. 1, a thread drive of the invention is identified overall by reference numeral 10. The thread drive comprises a threaded spindle 12, a load-bearing nut 14, and a safety nut 16. The threaded spindle is supported rotatably in a stationary bearing housing 36 by a bearing 34, which is embodied as a radial deep-groove ball bearing. The load-bearing nut 14, which is embodied as a ball race nut, is secured by screw bolts 42, shown in simplified form, to a higher-order component unit 26, which is supported counter to the direction of gravity G by the thread drive 10.

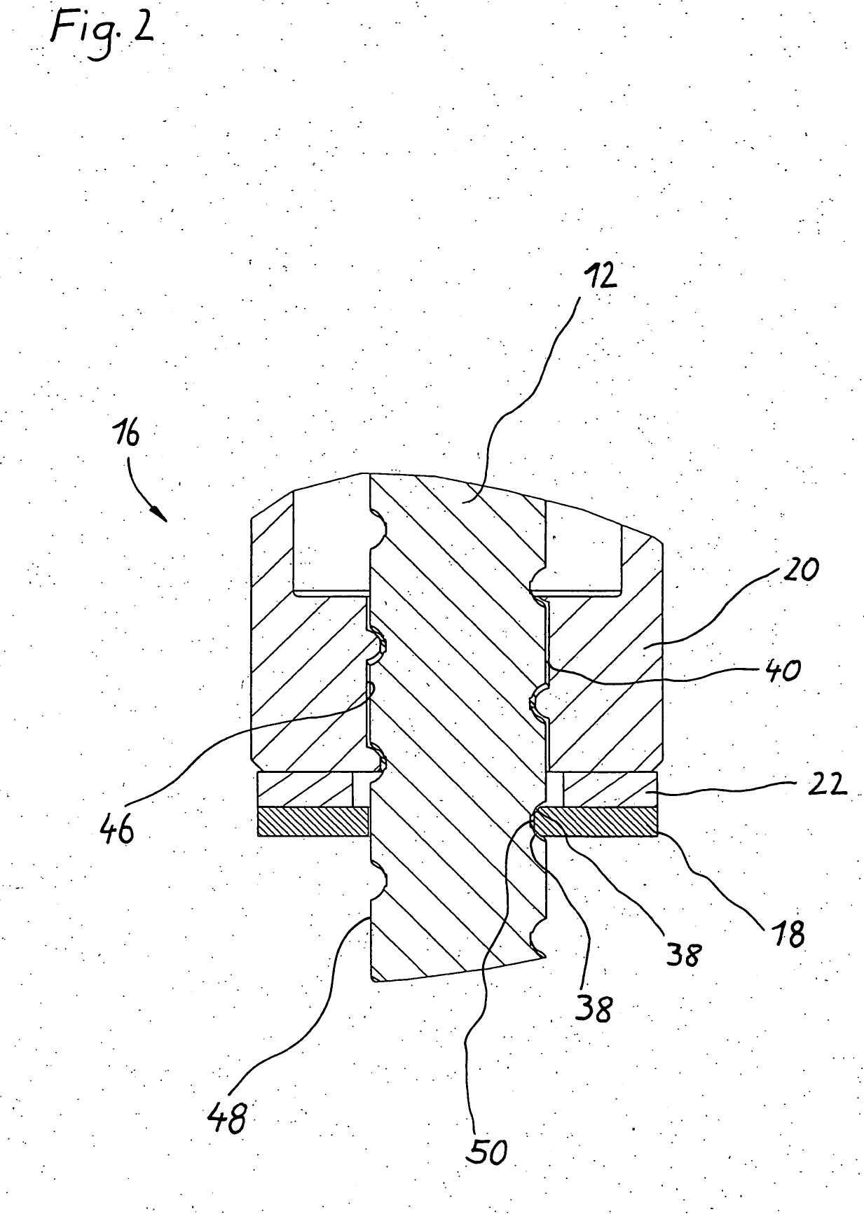

The safety nut 16, which is shown in more detail in FIG. 2, comprises a load-bearing portion 20 and a contact portion 18. The load-bearing portion and the contact portion are electrically insulated from one another by an electrically nonconductive component 22. The safety nut 16 is secured by screw bolts 44, also shown in simplified form, to the load-bearing nut in a manner fixed against relative rotation. The screw bolts 44 are provided with an electrically nonconductive coating, so that the contact portion 18 of the safety nut is completely electrically insulated from the rest of the thread drive.

The load-bearing portion 20 of the safety nut is embodied essentially as a hollow steel cylinder. Its inner circumferential surface 46 is embodied with a predetermined gap size equidistant from the outer circumferential surface 48 of the threaded spindle, so that a gap 40 is created.

The contact portion 18 of the safety nut is embodied as a steel disk, whose inner circumferential surface 50 in a contact region 38 is likewise embodied as equidistant from the outer circumferential surface 48 of the threaded spindle. However, the gap size is somewhat smaller than the aforementioned gap size between the load-bearing portion 20 and the threaded spindle 12. In the first operating state, the contact portion does not touch the threaded spindle. In the second operating state, namely if the load-bearing nut is broken, both the contact portion 18 and the load-bearing portion 20 of the safety nut are in contact with the threaded spindle 12.

Because of the different gap sizes and because of the elasticity of the rubber electrically nonconductive component 22, the contact portion 18, in the contact region 38, is in contact with the threaded spindle with a defined minimum contact pressure. The contact region 38 is located in the region of the ball travel traces of the ball race nut, since the threaded spindle 12 in this case is machined especially precisely.

The contact portion is connected by an electrical cord 30 to an evaluation device 28, which is connected by a further electrical cord 32 to the bearing housing 36. In the second operating state, the electrical circuit is thus closed via the electrically conductive bearing 34 and the threaded spindle 12. The closed circuit is detected by the evaluation device and reported to a higher-order controller.

One seal 24 each is located on the end regions of the combination comprising the load-bearing nut 14 and the safety nut 16. The seals on the one hand prevent lubricant from escaping from the ball race nut. They also prevent electrically conductive particles, such as metal chips, from the surroundings from being able to reach the contact region 38. The seals 24 are of rubber and are therefore electrically nonconductive, so that no unwanted electrical connection occurs between the contact portion 18 of the safety nut and the threaded spindle 12.

It will be understood that each of the elements described above, or two or more together, may also find a useful application in other types of constructions differing from the types described above.

While the invention has been illustrated and described as embodied in a thread drive with monitored safety nut, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A thread drive, comprising a threaded spindle; a load-bearing nut that is in screwing engagement with said threaded spindle; a safety nut connected to said load-bearing nut in a manner fixed against relative rotation, which is likewise in screwing engagement with said threaded spindle, said safety nut having at least one contact portion which has no contact with said threaded spindle in a first operating state of the thread drive and has contact with said threaded spindle in a second operating mode of the thread drive, so that in said first operating state there is no electrically conductive connection between said at least one contact portion of said safety nut and said threaded spindle.

2. A thread drive as defined in claim 1, wherein said at least one contact portion of said safety nut has an electrically insulating coating which interrupts the electrical connection between said contact portion of said safety nut and said threaded spindle.

3. A thread drive as defined in claim 1; and further comprising a separate, electrically nonconductive component which interrupts the electrical connection between said contact portion of said safety nut and said threaded spindle.

4. A thread drive as defined in claim 1, wherein said load-bearing nut is configured as a roller body circulation nut, and the electrical connection between said contact portion of said safety nut and said threaded spindle is interrupted by roller bodies of electrically nonconductive material.

5. A thread drive as defined in claim 4, wherein said roller bodies of electrically nonconductive material are configured as ceramic balls.

6. A thread drive as defined in claim 1, wherein said contact portion of said safety nut is configured as at least partly elastically shiftable relative to said load-bearing nut.

7. A thread drive as defined in claim 1; and further comprising an evaluation device which is electrically connected to said contact portion of said safety nut and to said threaded spindle by an electrical connection.

8. A thread drive as defined in claim 7; and further comprising at least one bearing which rotatably supports said threaded spindle, said electrical connection between said evaluation device and said threaded spindle extending via said bearing.

9. A thread drive as defined in claim 1; and further comprising means for applying ground potential to said threaded spindle.

10. A thread drive as defined in claim 1; and further comprising means for sealing of said contact region between said contact portion of said safety nut and said threaded spindle, from environment.

11. A thread drive as defined in claim 1; and further comprising an electrically nonconductive lubricant.
